(19) United States
(12) Patent Application Publication
(10) Pub. No.: US 2006/0209073 A1
(43) Pub. Date: Sep. 21, 2006

(54) Display device, display method, display program, and recording medium containing the display program

(75) Inventor: Kazuyuki Nako, Soraku-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi, Osaka 545-8522 (JP)

(21) Appl. No.: 10/516,881

(22) PCT Filed: Jun. 2, 2003
(86) PCT No.: PCT/JP03/06969

§ 371 Date: Dec. 3, 2004

(30) Foreign Application Priority Data
Jun. 7, 2002 (JP) 2002-167097

(51) Int. Cl. G06T 11/00

(52) U.S. Cl. 345/467

(57) ABSTRACT

In a PDA (100), a ROM (11) stores beforehand a character code for specifying each character in a text and character shape data corresponding to the character code in a correlated manner while a RAM (12) stores an image code for specifying a registered image and registered image data corresponding to the image code in a correlated manner according to registration processing by a user. Based on digitized document data containing a series of a character code, text attribute data, and an image code, a CPU (10) transforms the registered image to be displayed according to the text attribute data and then causes an LCD (13) to output the corresponding text and registered image simultaneously.

### TECHNICAL FIELD

The present invention relates to a technique for displaying a text and an image inserted therein simultaneously. More particularly, the present invention relates to a technique for displaying an image used as a substitute for a character in a balanced manner.

### BACKGROUND ART

With the development of computer technology in recent years, a document has increasingly been digitized and exchanged. In particular, a Hyper Text Markup Language (HTML) document, which is one of the digitized documents, has widely been used along with a Web browser displaying the document as Internet penetration rapidly increases. The Web browser is one of the viewer programs displaying an HTML document, allowing various representations such as displaying an image and a text in an HTML document simultaneously, and displaying a text by using various font types and by adding an attribute such as color, link, or underline.

A character shape which can be represented in a digitized document is usually defined by a font, and a character code and a character shape corresponding thereto are standardized to some extent. Therefore, in the case of document exchange between users, a viewer program can display the document correctly as long as a standard character is used. However, the use of a standard font makes it impossible to display a nonstandard special character, namely, the so-called “external character”. Accordingly, there is generally adopted a method of registering an external character in a user-defined area for a font, a method of selecting a font to display a certain character, or the like.

Furthermore, as another method for displaying an external character, there is generally adopted a method of embedding an external character as an image in a text. However, a mismatch in size between a text and an image results in an unbalanced representation. To resolve the problem, Japanese Patent Laying-Open No. 2001-22341 discloses a method of providing an external character as image data with its format and font type adjusted by an information supplier to enable the entire textual information to be displayed in a unified manner.

However, in a typical Web browser (such as Netscape Navigator (R) or Internet Explorer (R)), an image inserted into a text and displayed therewith is only processed as an image and cannot be displayed as a text, which can be displayed by adding thereto an attribute such as color, link, or underline.

The method of defining a font for an external character, and the method of using a font for a certain external character require not only a digitized document but a font to be transmitted to an information recipient in the document exchange, disadvantageously resulting in increased data volume. Furthermore, since a font is dependent on a system, a document exchange between different platforms particularly causes inconvenience in some cases. Additionally, it is technically difficult to define a font or to produce a new font while satisfying the need to ensure consistency of character codes. Therefore, a typical user cannot do this with ease.

The technique described in Japanese Patent Laying-Open No. 2001-22341 provides the method of transmitting a text and an external character image with their sizes adjusted to suit each other on the server side. Therefore, character size modification on the user side causes mismatch of the external character image and the text.

### DISCLOSURE OF THE INVENTION

An object of the present invention is to provide a display device, a display method and a viewer program for, even if an external character is inserted into a text as an image, transforming the image according to the text attribute for display.

According to an aspect of the present invention, a display device capable of displaying a text and a registered image inserted therein simultaneously comprises: a first storage portion for storing beforehand a character code for specifying each character in the text and character shape data corresponding to the character code in a correlated manner; a second storage portion for storing an image code for specifying the registered image and registered image data corresponding to the image code in a correlated manner according to registration processing by a user; a display output portion for outputting the text and the registered image; and a display control portion for causing the display output portion to output the corresponding text and registered image based on display data containing a series of the character code, text attribute data, and the image code, and the display control portion has an image transforming portion for transforming the registered image to be displayed according to the text attribute data.

According to the present invention, the image is transformed according to the text attribute and displayed. Therefore, especially if the image is embedded as an external character in the text, for example, there can be provided a display device capable of displaying the text and the image harmoniously.

Preferably, in the display device, the text attribute data contains size attribute data indicating a character size of a corresponding text, and the image transforming portion scales up/down the registered image according to the size attribute data.

According to the present invention, the image is scaled up/down according to the text's size attribute. Therefore, there can be provided a display device capable of displaying the text and the image in a balanced manner.

Preferably, in the display device, the text attribute data contains color attribute data indicating at least a fore color of a corresponding text, and the image transforming portion converts a color of the registered image according to the color attribute data.

According to the present invention, the color of the image is converted according to the text's color attribute. Therefore, there can be provided a display device capable of coloring the image as in the text and displaying the text and the image harmoniously.

More preferably, when the registered image is a gray image, the image transforming portion converts each pixel color into a color made by mixing the fore color and a back color of the text at a ratio according to a pixel value.

According to the present invention, when the registered image is a gray image, each pixel color is converted into a color made by mixing the fore color and the back color at a ratio according to a pixel value, resulting in that even a color of the image containing a halftone is converted into a natural gradient color. Therefore, there can be provided a display device capable of displaying the text and the image more harmoniously.

More preferably, in the display device, the text attribute data contains decoration attribute data indicating a type of a decoration applied to a corresponding text, and the image transforming portion decorates the registered image according to the decoration attribute data.

According to the present invention, the image is decorated according to the text's decoration attribute. Therefore, there can be provided a display device capable of displaying the text and the image harmoniously without any loss of decoration in the image portion.

According to another aspect of the present invention, a display method for displaying a text and a registered image inserted therein simultaneously, comprises the steps of: storing an image code for specifying the registered image and registered image data corresponding to the image code in a correlated manner according to registration processing by a user; with respect to display data containing a series of a character code, text attribute data, and the image code, transforming the registered image to be displayed according to the text attribute data; and displaying the text and the registered image simultaneously based on the transformed registered image, and the text attribute data and the character code for specifying each character in the text, and character shape data corresponding to the character code stored beforehand in a correlated manner.

According to the present invention, the image is transformed according to the text attribute and displayed. Therefore, especially if the image is embedded in the text as an external character, for example, there can be provided a display method capable of displaying the text and the image harmoniously.

According to still another aspect of the present invention, a viewer program for displaying a text and a registered image inserted therein simultaneously, causes a computer to perform the steps of: storing an image code for specifying the registered image and registered image data corresponding to the image code in a correlated manner according to registration processing by a user; with respect to display data containing a series of a character code, text attribute data, and the image code, transforming the registered image to be displayed according to the text attribute data; and displaying the text and the registered image simultaneously based on the transformed registered image, and the text attribute data and the character code for specifying each character in the text, and character shape data corresponding to the character code stored beforehand in a correlated manner.

According to the present invention, the image is transformed according to the text attribute and displayed. Therefore, especially if the image is embedded in the text as an external character, for example, there can be provided a viewer program capable of displaying the text and the image harmoniously.

According to a further aspect of the present invention, there is provided a computer-readable recording medium having a viewer program recorded thereon for displaying a text and a registered image inserted therein simultaneously. The viewer program causes a computer to perform the steps of: storing an image code for specifying the registered image and registered image data corresponding to the image code in a correlated manner according to registration processing by a user; with respect to display data containing a series of a character code, text attribute data, and the image code, transforming the registered image to be displayed according to the text attribute data; and displaying the text and the registered image simultaneously based on the transformed registered image, and the text attribute data and the character code for specifying each character in the text, and character shape data corresponding to the character code stored beforehand in a correlated manner.

### BRIEF DESCRIPTION OF THE DRAWINGS

FIG. 1 is an external view of a PDA 100, which is an example of a display device.

FIG. 2 is a schematic block diagram showing a structure of PDA 100.

FIG. 3 is a schematic view for describing a digitized document displayed on a display device according to a present embodiment.

FIG. 4 is a flowchart for describing a program executed in the display device according to the present embodiment.

FIG. 5 is a schematic view showing the digitized document in FIG. 3 in which a text and an external character are displayed simultaneously without undergoing the processing described in FIG. 4.

FIG. 6 is a schematic view showing the digitized document in FIG. 3 in which a text and an external character are displayed simultaneously after undergoing the processing described in FIG. 4.

FIG. 7 is a schematic view for describing a digitized document which is displayed on the display device according to the present embodiment and whose color attribute is specified.

FIG. 8 is a schematic view showing the digitized document in FIG. 7 in which a text and an external character are displayed simultaneously without undergoing the processing described in FIG. 4.

FIG. 9 is a schematic view showing the digitized document in FIG. 7 in which a text and an external character are displayed simultaneously after undergoing the processing described in FIG. 4.

FIG. 10 is a schematic view for describing a digitized document which is displayed on the display device according to the present embodiment and whose decoration attribute is specified.

FIG. 11 is a schematic view showing the digitized document in FIG. 10 in which a text and an external character are displayed simultaneously without undergoing the processing described in FIG. 4.

FIG. 12 is a schematic view showing the digitized document in FIG. 10 in which a text and an external character are displayed simultaneously after undergoing the processing described in FIG. 4.

FIG. 13 is a schematic view for describing a digitized document which is displayed on the display device according to the present embodiment and whose other decoration attributes are specified.

FIG. 14 is a schematic view showing the digitized document in FIG. 13 in which a text and an external character are displayed simultaneously without undergoing the processing described in FIG. 4.

FIG. 15 is a schematic view showing the digitized document in FIG. 13 in which a text and an external character are displayed simultaneously after undergoing the processing described in FIG. 4.

### BEST MODES FOR CARRYING OUT THE INVENTION

An embodiment of the present invention will be described below with reference to the drawings. In the description below, the same reference character is given to the same components, whose names and functions are the same as well. Therefore, the description thereof will not be repeated.

Processing in a display device according to the present embodiment is implemented by software executed on a computer such as a personal computer, a workstation, or Personal Digital Assistants or Personal Data Assistants (PDA) serving as a handheld device. The processing may be implemented, not by such a general-purpose computer, but by a special-purpose display device.

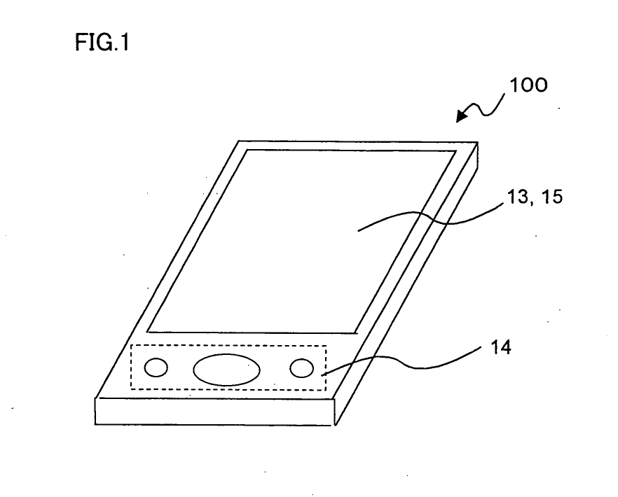

FIG. 1 is an external view of a PDA 100, which is an example of a display device.

Referring to FIG. 1, PDA 100 includes a Liquid Crystal Display (LCD) 13 serving as a display means, a key 14 and a touch panel 15 which are an operating mechanism serving as an interface with a user.

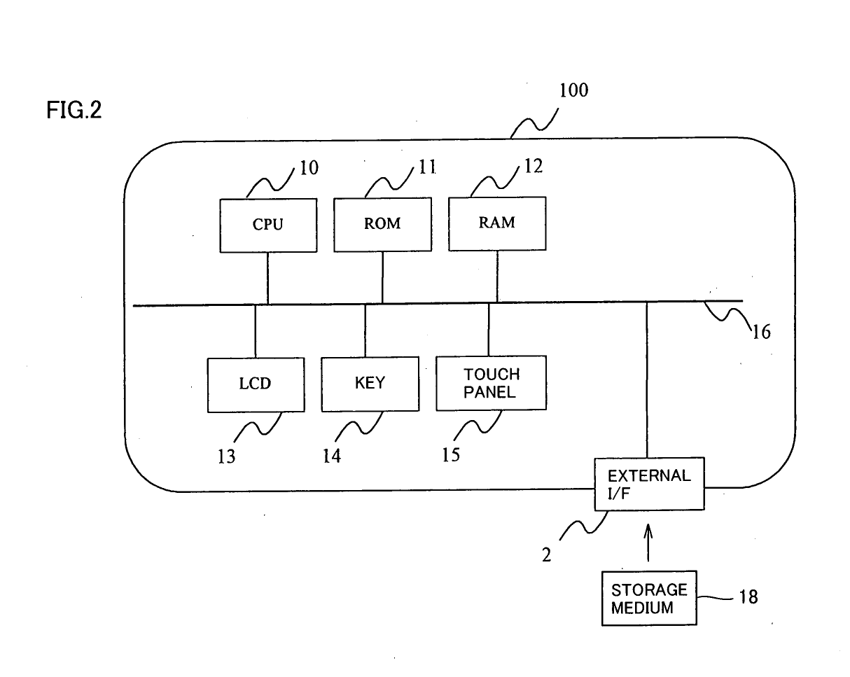

FIG. 2 is a schematic block diagram showing a structure of PDA 100.

Referring to FIG. 2, PDA 100 further includes, in addition to the above-mentioned LCD 13, key 14, and touch panel 15, a Central Processing Unit (CPU) 10, a Read Only Memory (ROM) 11, and a Random Access Memory (RAM) 12 which are mutually connected via a bus 16. PDA 100 also includes an external interface 2 (hereinafter referred to as “external I/F 2”) for connecting to an external computer, a recording medium 18, and the like.

RAM 12 is used not only as a location for storing a program and data, but as a working area required to execute the program.

As previously described, a function of the display device according to the present embodiment is implemented by computer hardware and software executed by CPU 10. Generally, such software is stored on recording medium 18 such as a Compact Disk-Read Only Memory (CD-ROM), a floppy (R) disk, or a memory card, which are not shown, and commercially distributed. For PDA 100, such software is firstly stored in RAM 12 via external I/F 2 through a personal computer, for example, or directly from recording medium 18, and then executed by CPU 10. The hardware itself of PDA 100 shown in FIGS. 1 and 2 is a commonly-used one. Therefore, in the present invention, software recorded on a recording medium such as a CD-ROM, a floppy (R) disk, or RAM 12 implements an essential function.

In order to display text data on LCD 13, a character code and character shape data corresponding thereto are stored beforehand in a correlated manner in ROM 11 at the time when PDA 100 is manufactured, for example. According to the data for specifying a display text given from a user, a character which has a size and a color conforming to the data, and furthermore, to which a decoration and the like is applied as required is displayed on LCD 13 according to the processing in CPU 10.

In contrast, for an external character and graphics registered by a user, an “external character code” or an “image code” specified by a user and graphics data corresponding thereto are stored in a correlated manner in RAM 12, for example. The “external character code” or the “image code” and the graphics data corresponding thereto may be input by a user via key 14 or touch panel 15 of PDA 100, or may be produced as data by the external personal computer and input via external I/F 2. CPU 10 reads the data of a digitized document input by a user and stored in RAM 12 and, based on the data, displays the text and the image on LCD 13.

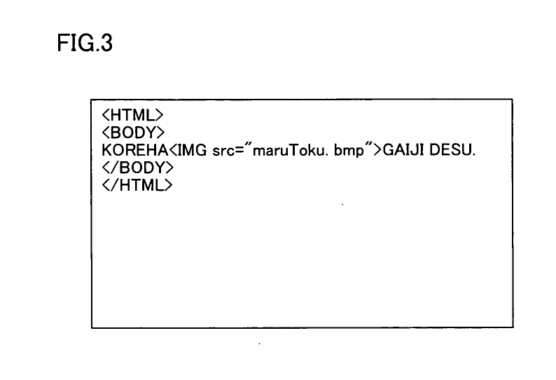

Since other operations of PDA 100 itself shown in FIGS. 1 and 2 are well known, the detailed description thereof will not be repeated herein. FIG. 3 is a schematic view for describing a digitized document displayed on the display device according to the present embodiment. The digitized document shown in FIG. 3 is written in a Hyper Text Markup Language (HTML) format. However, it may be written in other formats.

In the HTML, the text's format, structure, and link to other documents are described with a tag (a portion sandwiched between “<” and “>”) and an element sandwiched between the tags. The HTML document is generally displayed by a viewer program called a Web browser.

In FIG. 3, an external character is specified by “maruToku. bmp”, which is a code indicating an external character registered by a user. With the description “KOREHA<IMG src=“maruToku. bmp”>GAIJI DESU.” in a row in FIG. 3, an external character [symbol] registered as graphics is specified to be displayed between the texts “KOREHA” and “GAIJI DESU”.

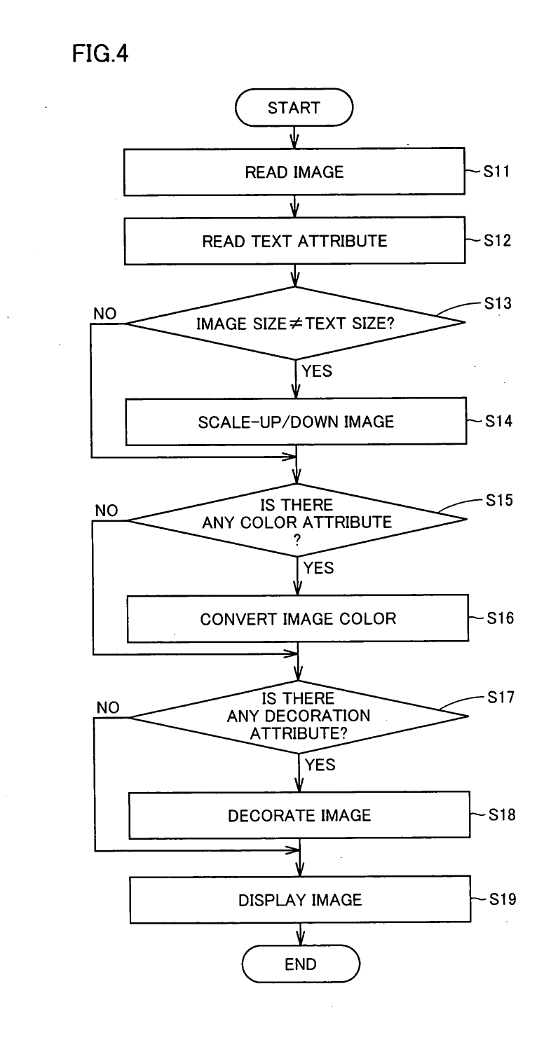

FIG. 4 is a flowchart for describing a program executed in the display device according to the present embodiment. A program executed in the display device according to the present embodiment has a control structure below with regard to display processing.

Before CPU 10 starts the processing shown in FIG. 4, an image code for specifying the above-mentioned external character or graphics and the external character or graphics corresponding to the image code have been stored beforehand in a correlated manner in RAM 12 according to the registration by a user.

In step S11, CPU 10 reads image data corresponding to an external character from a digitized document stored in RAM 12. The digitized document may be a single file, or may be configured of a plurality of files. The image data need not always represent the so-called “external character”, and may represent graphics registered beforehand by a user, assuming that it is inserted into a text and displayed therewith.

In step S12, CPU 10 reads a text attribute from the digitized document stored in RAM 12. Though the “text attribute” refers to a size, a color attribute, and a decoration attribute in the present embodiment, it may be other attributes. The “size” means a font size. The “color attribute” means the text's fore color, back color, and others. The “decoration attribute” means a type of a decoration added to a character shape corresponding to the character code, such as an underline or a cancel line. In some cases where a text attribute is not written in a digitized document, it means that a default attribute is implicitly indicated.

In step S13, CPU 10 determines whether or not an image size matches a text size. If the sizes do not match (YES in step S13), the processing proceeds to step S14. If the sizes match (NO in step S13), the processing proceeds to step S15.

In step S14, CPU 10 executes processing of scaling up or down to match the image with the text size.

In step S15, CPU 10 determines whether or not a color attribute is specified as a text attribute. If it is specified (YES in step S15), the processing proceeds to step S16. If it is not specified (NO in step S15), the processing proceeds to step S17. The color attribute may be specified not only explicitly but implicitly as well by a default value for a specific function such as a link.

In step S16, CPU 10 executes color conversion processing on the image according to the text's color attribute.

In step S17, CPU 10 determines whether or not a decoration attribute is specified in a text attribute. If it is specified (YES in step S17), the processing proceeds to step S18. If it is not specified (NO in step S17), the processing proceeds to step S19. In the “decoration attribute”, not only an underline, a cancel line, and others may explicitly be specified, but also a default value for a specific function such as a link may implicitly be specified.

In step S18, CPU 10 executes decoration processing on the image according to the decoration attribute.

In step S19, CPU 10 displays on LCD 13 the image on which the above transforming processing has been executed. The decoration processing executed by CPU 10 in step S18 may be implemented by overwriting the image displayed in step S19.

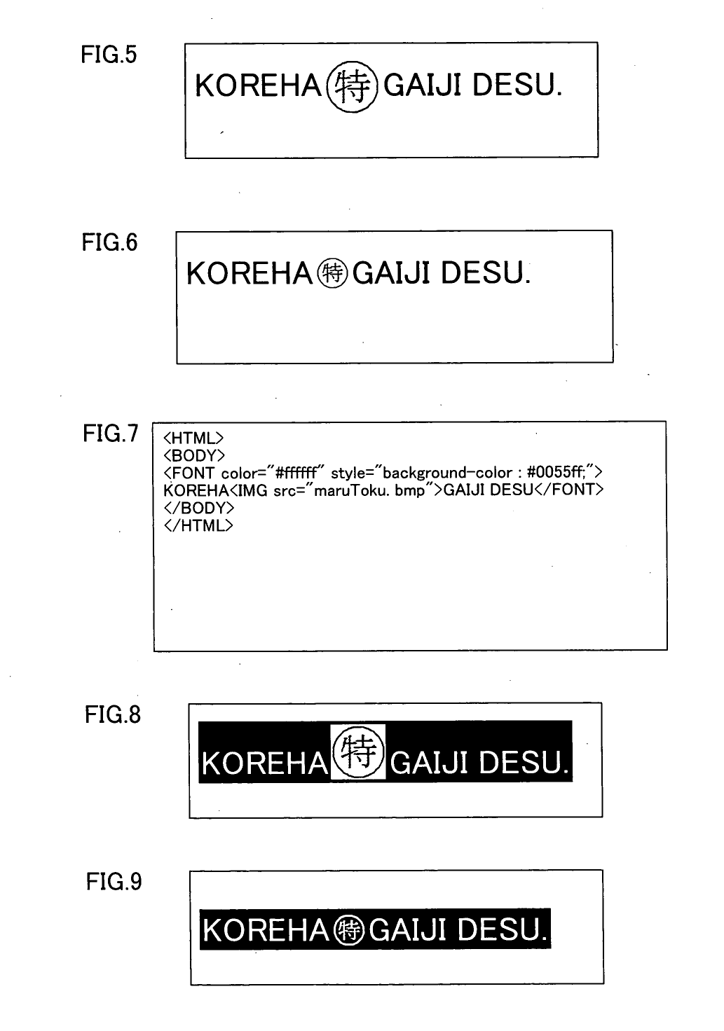

FIG. 5 is a schematic view showing a text and an external character displayed simultaneously without undergoing the processing described in FIG. 4. FIG. 6 is a schematic view showing a text and an external character displayed simultaneously after undergoing the processing described in FIG. 4.

Referring to FIGS. 3 and 4, and FIGS. 5 and 6, the processing of scaling up/down the image executed by CPU 10 in step S14 in FIG. 4 will be described.

In the digitized document shown in FIG. 3, an image [symbol] specified as “maruToku. bmp” is inserted into a text “KOREHA GAIJI DESU” (This is an external character.). If the image size is larger than the text size, the balance between the image and the text is lost as shown in FIG. 5 in the conventional Web browser. The same applies to the case where the image is smaller than the text.

In step S14 in FIG. 4, CPU 10 scales up/down the image Ty/Iy-fold, where Ty is a height of the text while Iy is a height of the image. If the image is a vector image, the processing of scaling up/down is implemented by a coordinate transformation. If the image is a bitmapped image, the processing of scaling up/down is implemented by a coordinate transformation and interpolation processing. Since the processing of scaling up/down the image is a known technique, the detailed description thereof will not be repeated.

With the display device in accordance with the present embodiment, the image inserted into the text is adjusted to suit the text size and displayed as shown in FIG. 6. Therefore, the character and the image can be displayed without losing the balance thereof. Though the present embodiment provides an example of horizontal writing, the processing of scaling up/down for vertical writing may be executed to adjust the image width to the text width serving as a reference.

FIG. 7 is a schematic view for describing a digitized document which is displayed on the display device according to the present embodiment and whose color attribute is specified. FIG. 8 is a schematic view showing a text and an external character displayed simultaneously without undergoing the processing described in FIG. 4. FIG. 9 is a schematic view showing a text and an external character displayed simultaneously after undergoing the processing described in FIG. 4.

Referring to FIGS. 7, 8 and 9, the color conversion processing for the image executed by CPU 10 in step S16 in FIG. 4 will be described. In the digitized document shown in FIG. 7, an image [symbol] specified as “maruToku. bmp” is inserted into a text “KOREHA GAIJI DESU” (This is an external character.), and a fore color (#ffffff) and a back color (#0055ff) are set in the entire text.

As shown in FIG. 8, the image is displayed as it is in the conventional Web browser. Therefore, the text and the image displayed simultaneously show different fore colors and back colors, resulting in unnatural representation.

In step S16 in FIG. 4, CPU 10 executes the color conversion processing by transforming the image's pixel value for a R (red) component, for example, based on an equation below.
(R component of pixel value′)=((pixel value)*(R component of back color)+(255−(pixel value))*(R component of fore color))/255

Here, the image before color conversion is a gray image, and assumes a value ranging from 0 to 255, where 0 corresponds to black while 255 corresponds to white. The operation according to the above equation is related to a R (red) component, and the similar operation is performed to color components of G (green) and B (blue). After the color conversion according to the above equation, the image becomes a color image.

The number of gray levels in the image is not necessarily 256, and may be 2 or 4. When the image before color conversion is a color image, for example, only a specific color may be replaced with another color for conversion without depending on the operation above. For example, white and black may be converted to a back color and a fore color, respectively.

With the display device in accordance with the present embodiment, a color of the image inserted into the text is converted according to the text's color attribute and displayed as shown in FIG. 9. Therefore, the character and the text can be displayed harmoniously.

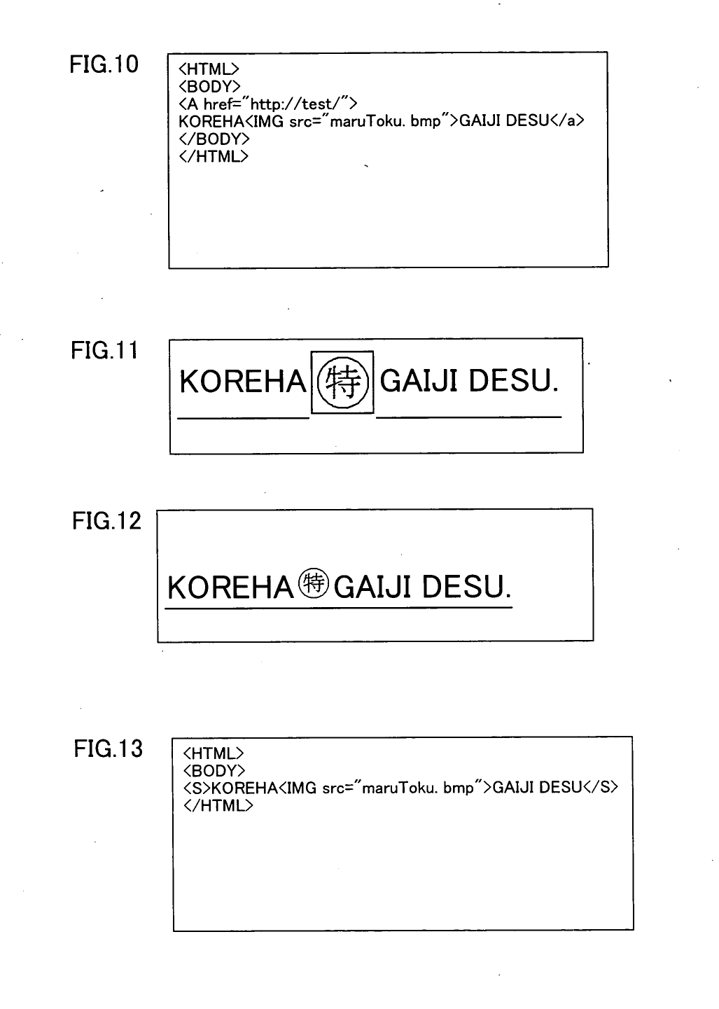

FIG. 10 is a schematic view for describing a digitized document which is displayed on the display device according to the present embodiment and whose decoration attribute is specified. FIG. 11 is a schematic view showing a text and an external character displayed simultaneously without undergoing the processing described in FIG. 4. FIG. 12 is a schematic view showing a text and an external character displayed simultaneously after undergoing the processing described in FIG. 4.

Referring to FIGS. 10, 11 and 12, the decoration processing for the image executed by CPU 10 in step S18 in FIG. 4 will be described.

In the digitized document shown in FIG. 10, an image [symbol] specified as “maruToku. bmp” is inserted into a text “KOREHA GAIJI DESU” (This is an external character.), and a link is provided to the entire text and the image.

In the conventional Web browser, as shown in FIG. 11, the text portion displays an underline indicating a link while the image portion displays a square drawn as an outline of the image, resulting in inharmonious representation in the text and the image. Furthermore, the link is usually displayed in a color different from that of the normal text. The description thereof will not be repeated herein because it has already been referred to in the description of the processing in step S16.

In step S18, CPU 10 draws an underline below the image as in the text. An underline may be drawn directly below the image itself, or may not be drawn in step S18. Instead, in step S19, when CPU 10 displays the image, an underline may be drawn on the displayed image.

With the display device in accordance with the present embodiment, the decoration processing is executed on the image inserted into the text according to the text's decoration attribute as shown in FIG. 12. Therefore, the character and the image can be displayed harmoniously.

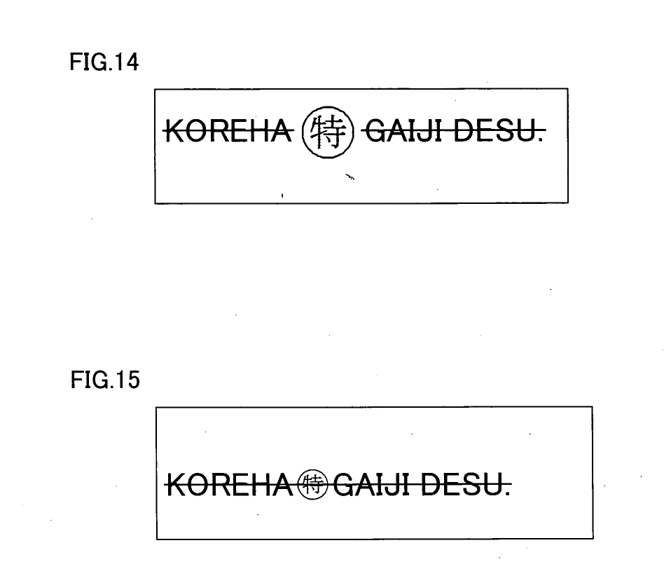

FIG. 13 is a schematic view for describing a digitized document which is displayed on the display device according to the present embodiment and whose other decoration attributes are specified. FIG. 14 is a schematic view showing a text and an external character displayed simultaneously without undergoing the processing described in FIG. 4. FIG. 15 is a schematic view showing a text and an external character displayed simultaneously after undergoing the processing described in FIG. 4.

Referring to FIGS. 13, 14 and 15, the decoration processing for the image executed by CPU 10 in step S18 will be described by using another example.

In the digitized document shown in FIG. 13, an image [symbol] specified as “maruToku. bmp” is inserted into a text “KOREHA GAIJI DESU” (This is an external character.), and a cancel line attribute is set in the entire text.

In the conventional Web browser, as shown in FIG. 14, the text portion displays a cancel line while the image portion displays no line.

In step S18 in FIG. 4, CPU 10 draws a cancel line on the image as in the text. A cancel line may be drawn directly on the image itself, or may not be drawn in step S18. Instead, in step S19, when CPU 10 displays the image, a cancel line may be drawn on the displayed image.

With the display device in accordance with the present embodiment, the decoration processing is executed on the image inserted into the text according to the text's decoration attribute as shown in FIG. 15. Therefore, the character and the image can be displayed harmoniously.

For the purpose of clarity, the present embodiment exemplifies a digitized document in an HTML format. However, the present invention can be applied to any other formats at least as long as display processing is executed based on data containing a character code for specifying the text to be displayed and an external character code or an image code for specifying the image registered beforehand by a user.

Furthermore, in the digitized document, the registered image may include a normal image and an external character image differentially described so that they can have attributes respectively. The relevant image portion may thus have an option of undergoing, or, not undergoing the above-mentioned processing which allows itself to be displayed similarly to the text.

As described above, according to the display device in accordance with the present invention, even if an external character, for example, is inserted into the text as an image, the image is scaled up/down according to the text's size attribute, subjected to color conversion according to the text's color attribute, and decorated according to the text's decoration attribute. By doing so, there can be implemented a display device capable of displaying harmoniously a text and an external character, for example, embedded therein as an image.

Although the present invention has been described and illustrated in detail, it is clearly understood that the same is by way of illustration and example only and is not to be taken by way of limitation, the spirit and scope of the present invention being limited only by the terms of the appended claims.

1. A display device capable of displaying a text and a registered image inserted therein simultaneously comprising:
a first storage portion (11) for storing beforehand a character code for specifying each character in said text and character shape data corresponding to said character code in a correlated manner;
a second storage portion (12) for storing an image code for specifying said registered image and registered image data corresponding to said image code in a correlated manner according to registration processing by a user;
a display output portion (13) for outputting said text and said registered image; and
a display control portion (10) for causing said display output portion to output corresponding said text and said registered image based on display data containing a series of said character code, text attribute data, and said image code, wherein said display control portion has image transforming means (S14, S16, S18) for transforming said registered image to be displayed according to said text attribute data.

2. The display device according to claim 1, wherein
said text attribute data contains size attribute data indicating a character size of the corresponding text, and
said image transforming means scales up/down said registered image according to said size attribute data.

3. The display device according to claim 1, wherein
said text attribute data contains color attribute data indicating at least a fore color of a corresponding text, and
said image transforming means converts a color of said registered image according to said color attribute data.

4. The display device according to claim 3, wherein when said registered image is a gray image, said image transforming means converts each pixel into a color made by mixing the fore color and a back color of said text at a ratio according to a pixel value.

5. The display device according to claim 1, wherein
said text attribute data contains decoration attribute data indicating a type of a decoration applied to a corresponding text, and
said image transforming means decorates said registered image according to said decoration attribute data.

6. A display method for displaying a text and a registered image inserted therein simultaneously, comprising the steps of:
storing an image code for specifying said registered image and registered image data corresponding to said image code in a correlated manner according to registration processing by a user;
with respect to display data containing a series of a character code, text attribute data, and said image code, transforming (S14, S16, S18) said registered image to be displayed according to said text attribute data; and
displaying (S19) said text and said registered image simultaneously based on said transformed registered image, and said text attribute data and the character code for specifying each character in said text, and character shape data corresponding to said character code stored beforehand in a correlated manner.

7. A viewer program for displaying a text and a registered image inserted therein simultaneously, causing a computer to perform the steps of:
storing an image code for specifying said registered image and registered image data corresponding to said image code in a correlated manner according to registration processing by a user;
with respect to display data containing a series of a character code, text attribute data, and said image code, transforming said registered image to be displayed according to said text attribute data; and
displaying said text and said registered image simultaneously based on said transformed registered image, and said text attribute data and the character code for specifying each character in said text, and character shape data corresponding to said character code stored beforehand in a correlated manner.

8. A computer-readable recording medium (18) having a viewer program recorded thereon for displaying a text and a registered image inserted therein simultaneously, said viewer program causing a computer to perform the steps of:
storing an image code for specifying said registered image and registered image data corresponding to said image code in a correlated manner according to registration processing by a user;
with respect to display data containing a series of a character code, text attribute data, and said image code, transforming said registered image to be displayed according to said text attribute data; and
displaying said text and said registered image simultaneously based on said transformed registered image, and said text attribute data and the character code for specifying each character in said text, and character shape data corresponding to said character code stored beforehand in a correlated manner.
